(19) United States
(12) Patent Application Publication
(10) Pub. No.: US 2005/0105228 A1
(43) Pub. Date: May 19, 2005

(54) Receptacle

(76) Inventors: Cheon-Youn Kim, Incheon (KR); Dong seb Kim, Kyeongsan-Si (KR); Seok-Won Song, Kwangju (KR); Dae-Gun Kim, Anyang-Si (KR)

Correspondence Address: RABIN & Berdo, PC, 1101 14TH STREET, NW, SUITE 500, WASHINGTON, DC, 20005, US

(21) Appl. No.: 10/988,549

(22) Filed: Nov. 16, 2004

(30) Foreign Application Priority Data
Nov. 18, 2003 (KR) 2003-0081696

(51) Int. Cl. H02H 3/18

(52) U.S. Cl. 361/85

(57) ABSTRACT

The present invention relates to a receptacle for preventing an accident due to errors due to wiring defects in wiring in advance by detecting the errors due to the wiring defects when initially wiring to the receptacle. The receptacle includes a main body, a cover for covering the main body, an input terminal and an output terminal received between the main body and the cover, a solenoid provided with a plunger magnetized by a circuit signal when an abnormal electric current such as electric arc, an electric leakage, or the like is generated at the input terminal or the output terminal, and an intermittent section, operatively associated with the solenoid, for preventing the abnormal electric current from flowing to a load. The intermittent section includes a latchet with which the plunger of the solenoid is associated, a housing into which the latchet is inserted and guided, and on which a contact of the input terminal is placed, and a reset inserted into the housing and formed with a locking recess locked by the latchet

### BACKGROUND OF THE INVENTION

1. Field of the Invention

The present invention relates to receptacles used in a power distribution system, and more particularly to a receptacle for preventing an accident due to errors due to wiring defects in wiring in advance by detecting the errors due to the wiring defects when initially wiring to the receptacle.

2. Background of the Related Art

Generally, electric power cables are installed to a various places such as underground, the inside of the wall, and the inside of the ceiling. When the unbalance of electric bolt such as the electric leakage, occurrence of an electric arc, or the like is generated when the electric power cable is damaged by a variety of reasons, such as thermal deterioration, aging, humidity, or a mouse, various office equipments, an electric heater, and the like using the electric current are affected.

Moreover, since when an overload is generated in the electric appliance itself in use, the overload affects another electric appliances using a common receptacle, there are so many problems of bringing errors, of becoming a reason for the defect, of making a fire, and of causing electric shock due to a user's mistake.

A receptacle or a circuit breaker, invented to solve the above problems intercepts an abnormal electric current occurring at the electric power cable, or the like prior to affection to the electric appliances or human, so as to prevent the error or faults of the electric appliance, a fire, or the electric shock in advance.

Here, the receptacle or the electric breaker includes an input terminal having a terminal for connecting an electric cable through which the electric current flows, and an output terminal formed with insertion holes into which plugs are inserted so as to supply the electric current to the electric office appliances, the electric heater, or the like.

Moreover, the receptacle or the electric breaker further includes an intermittent section having an electric circuit for driving bimetals or solenoids in recent so as to intercept the abnormal electric current such as the electric arc, the overload which are generated from the input terminal or the output terminal.

In other words, while using the electric current by connecting respective contacts provided at one of the input terminal and the output terminal, the intermittent section detects the abnormal electric current when the abnormal electric current isoccurred due to the, electric power cables or external circumstance at the input terminal or the output terminal, and disconnects the connected points between the input terminal and the output terminal so as to intercept the abnormal electric current flow to the output terminal or the input terminal.

The receptacle or the electric breaker having the above functions are various in view of uses, position, and using method, one of them, the construction an operation of a Korean Patent Application No. 2003-0001099 filed by this applicant as an example of the receptacle or the electric breaker will be described.

FIG. 1 is a plan view illustrating a conventional receptacle including an insulating outer case 10, a cover 20 coupled to the insulating outer case 10, a test button 30 disposed in the insulating outer case 10 and having an upper end exposed through the cover 20, and a reset button 40 disposed in the insulating outer case 10 and having an upper end exposed through the cover 20.

A yoke 50 is coupled between the insulating outer case 10 and the cover 20, formed with coupling holes at an side and the other side of the yoke 50, so as to easily fix the receptacle 1 to the wall of a house in which the electric wire is installed using bolts or screws.

FIG. 2 is a sectional view of the receptacle, as shown in FIG. 2, the cover 20 is provided with an output terminal, is formed with respective button holes 23 and 24 through which the upper ends of the test button 30 and the reset button 40 are exposed to the exterior, and formed with at least a connecting hole 26 into which a plug of an electric office appliance or an electric heater.

Moreover, the insulating outer case 10 includes an input terminal, and an intermittent section for intercepting the contact between the input terminal and the output terminal when the abnormal electric current is detected within the input signal supplied to the input terminal. The intermittent section is connected to a contact of the output terminal.

The test button 30 presses a trip switch 64 disposed at the lower surface of the insulating outer case 10, and the reset button 40 presses a reset switch 62 disposed at the lower surface of the insulating outer case 10.

FIG. 3 is an enlarged perspective view of the reset button, the intermittent section includes a reset button 40 having a button body 42 at an end of the reset button 40, and a shaft extended from the button body 42 and formed with a locking recess 44a at a side of the shaft 4, a reset guide 80 provided with a locking passage 82, formed in the vertical direction, for receiving the shaft of the reset button 40, and a pressing boss 84 for pressing the reset switch 62 formed at a side of the reset guide 80, a bracket 70 inserted into the locking passage 82 of the reset guide 80, and formed with a longitudinal hole 72 for intermitting the locking recess 44a of the shaft 44, and a solenoid 90, provided at the side of the bracket 70, for controlling the reset button 40 when sliding.

Further, the intermittent section further includes a spring between the reset button 40 and the yoke 50.

The reset guide 80 includes a support 86, provided at the side of the reset guide 80, to which the contact of the input terminal, and constructed so that the input terminal and the output terminal are connected to each other or disconnected from each other according to the elevation or the lowering of the reset guide 80.

Meanwhile, the test button 30 is used when testing whether the receptacle 1 is normal or not by operating the trip switch 64 fixed to a circuit board 60 disposed to the lower side of the insulating outer case 10.

The operation of the receptacle constructed as describe above will be described. The receptacle 1 is coupled with the cover 20. The cover includes the insulating outer case 10 having an input terminal for connecting an input electric power cable, a receptacle for outputting the electric current, and the output terminal for connecting an output electric power cable.

With reference to FIG. 3, in the state that the contact of the input terminal is spaced apart from the contact of the output terminal by a predetermined distance, the contact of the input terminal is maintained to be supported by the support 86 of the reset guide 80.

Here, a user completes wiring between an input electric power cable and an output electric power cable to the input terminal and the output terminal, respectively, as shown in FIG. 2, and presses the reset button 40 protruded through the button hole 24 of the cover 20.

At that time, in the pressed reset button 40, the shaft 44 extended from the button body 42 lowers, and the locking recess 44a formed at the side of the shaft 44 is locked by the side of the longitudinal hole 72 of the bracket 70 inserted into the locking passage 82 of the reset guide 80.

Moreover, the spring 46 between the reset button 40 and the yoke 50 is compressed due to the pressure, and the reset button 40 locked by the longitudinal hole 72 of the bracket 70 and the reset guide 80 into which the bracket 70 is inserted are elevated together due to the elastic force of the spring 46.

The elevating reset guide 80 elevates the contact of the input terminal supported by the support 86 provided at the side of the reset guide 80 so as to connect the contact of the input terminal to the contact of the output terminal, so that the input terminal is electrically connected to the output terminal.

When the compressed spring 46 is restored due to the elastic force, the button body 42 of the reset button 40 is locked into the cover 20, so that the compressing force is not fully disappeared, but remains in the spring 46.

Therefore, when the abnormal electric current is generated due to the input electric power cable or other external reasons in using the receptacle 1, a circuit connected to the input terminal detects the abnormal electric current to magnetize the solenoid 90.

The magnetized solenoid 90 has pulling force and retreats the bracket rearward.

In this case, due to the retreat of the bracket 70, the reset button 40 and the reset guide 80 locked by the bracket 70 are unlocked so that the reset button 40 ascends and the reset guide 80 lowers.

In other words, in the state that the end of the longitudinal hole 72 of the bracket 70 is locked into the locking recess 44a formed at the side of the reset button 40, the ned of the longitudinal hole 72 is separated from the locking recess 44a due to the retreat of the bracket 70, and the reset button 40 ascends between the yoke 50 and the button body 42due to the elastic force of the spring 46 storing the compression force.

In addition, since the reset guide 80 is descended due to the elastic force of the input terminal that has been supported and compulsorily ascended by the support 86, the contact between the contact of the input terminal and the contact of the output terminal is released to interrupt the electric current, so that the electric office appliances and the electric heater using the output terminal and the output electric power cable can be protected.

However, in the state that the input terminal of the receptacle or the electric breaker is connected with the output electric power cable and the output terminal of the receptacle is connected with the input electric power cable by the operator's mistake, if the abnormal electric current is generated by the external reason or the input electric power cable, the electric current directly flows to the output terminal to which the input electric power cable is connected in serial, and the abnormal electric current is transmitted to the electric heater and the electric power cable using the output terminal, so that there happen accidents such as errors, damages, fire of the electric appliances.

Moreover, since there is no device for examining the wiring defect in advance, entire power distribution system must be examined when the wiring defect is generated in a big building electrically wired by the power distribution system.

### SUMMARY OF THE INVENTION

Therefore, the present invention is made to solve such the problems, it is an object of the invention to provide a receptacle for preventing an accident due to errors due to wiring defects in wiring in advance by means of a device for self-detecting the errors due to the defects of electric power cables wired to the receptacle.

In order to accomplish the objects, the present invention provides a receptacle including a main body, a cover for covering the main body, an input terminal and an output terminal received between the main body and the cover, a solenoid provided with a plunger magnetized by a circuit signal when an abnormal electric current such as electric arc, an electric leakage, or the like is generated at the input terminal or the output terminal, and an intermittent section, operatively associated with the solenoid, for preventing the abnormal electric current from flowing to a load, wherein the intermittent section includes a latchet with which the plunger of the solenoid is associated, a housing into which the latchet is inserted and guided, and on which a contact of the input terminal is placed, and a reset inserted into the housing and formed with a locking recess locked by the latchet

Preferably, the latchet is formed with a guide hole at an end of the latchet, by which the end of the plunger of the solenoid is locked, and formed with a locking hole at the other end of the latchet for intermitting the locking hole of the reset.

The housing includes a body, an insertion hole penetrating the side of the body in which a side of the reset is inserted, a locking passage formed in the perpendicular direction to the insertion hole of the body for guiding an end of the ratchet, supports, extended from the body, for supporting the contact of the input terminal or the output terminal, and a pressing boss, extended from a side of the body, for pressing a reset switch.

The reset includes a button body protruding to the exterior of the cover, and a pestle extended from the button body, inserted into the insertion hole of the housing, and formed with at least one locking recess.

The intermittent section includes a latchet formed with a guide hole at an end of the latchet, by which the end of the plunger of the solenoid is locked, and formed with a locking hole at the other end of the latchet for intermitting the locking hole of the reset, a housing includes a body formed with an insertion hole into which a side of the latchet formed with the locking hole is inserted, a locking passage formed in perpendicular to the insertion hole of the body so as to guide the side of the latchet, at least one support, extended from the body, for supporting the contact of the input terminal or the output terminal, and a pressing boss, formed at the lower side of the body, for pressing a reset switch, and a reset having a button body protruding to the exterior of the cover, and at least one pestle extended from the button body and inserted into the insertion hole of the housing.

According to the aspect of the present invention, the reset further includes an elastic component for providing a restoring force after pressing.

The elastic component is a compression spring.

According to the aspect of the present invention, the locking recess includes a first locking recess intermitted by being locked in the locking hole and maintained in the locked state when the solenoid is not magnetized due to the defect suxh as the wiring defect as pressing the reset, and a second locking recesses for connecting the contact of the input terminal to the contact of the output terminal by which the first locking recess is locked again after the release from the locking hole of the latchet by which the solenoid is magnetized at the normal wiring that an abnormal signal is not detected.

The first locking recess has a semi-cylindrical shape formed by cutting a side of the cylinder.

The second locking recess has recesses formed on the sides of the pestle at a predetermined depth.

### BRIEF DESCRIPTION OF THE DRAWINGS

These and other features, aspects, and advantages of the present invention will become better understood with regard to the following description, appended claims, and accompanying drawings, in which like components are referred to by like reference numerals. In the drawings:

FIG. 1 is a plan view illustrating a conventional receptacle;

FIG. 2 is a horizontal sectional view illustrating the conventional receptacle;

FIG. 3 is a perspective view illustrating a pressing boss of a reset button of the conventional receptacle;

FIG. 4 is an enlarged separate perspective view illustrating a main part of an intermittent section of a receptacle according to the present invention;

FIGS. 5a and 5b are a sectional view of the intermittent section of the receptacle according to the present invention and an enlarged sectional view of the main part of the intermittent section before examining the wiring defect;

FIGS. 6a and 6b are a sectional view of the intermittent section of the receptacle according to the present invention and an enlarged sectional view of the main part of the intermittent section after examining the wiring defect; and

FIG. 7 is a circuit of the receptacle according to the present invention.

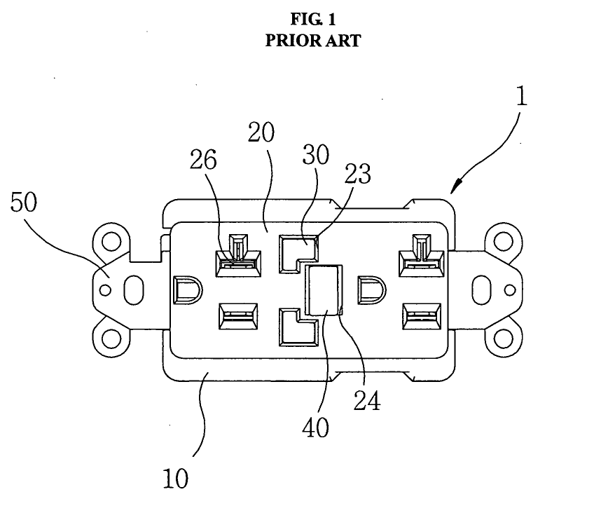

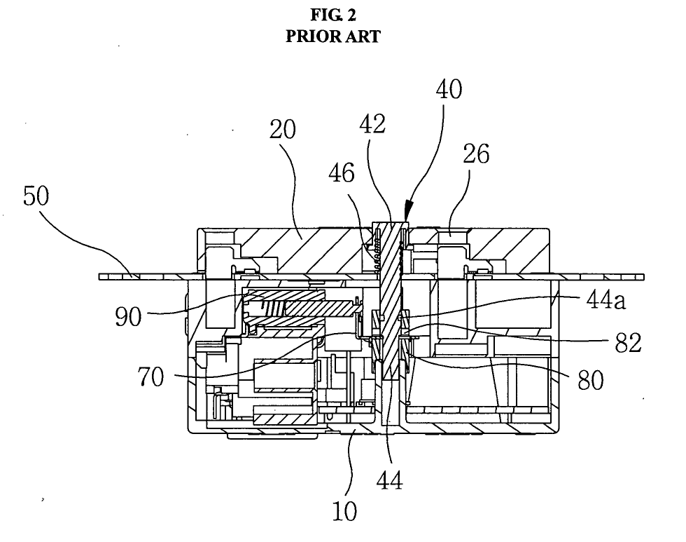

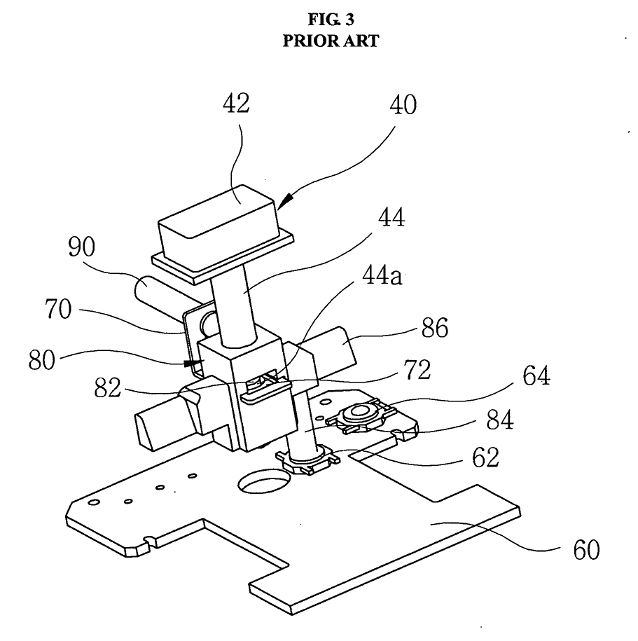

### DETAILED DESCRIPTION OF THE PREFERRED EMBODIMENT

Hereinafter, the present invention will be described in detail with reference to the accompanying drawings.

A receptacle I includes a main body 10, a cover for covering the main body 10, an input terminal 12 and an output terminal 22 received between the main body 10 and the cover 20, a solenoid 90 provided with a plunger 92 magnetized by a circuit signal when an abnormal electric current such as electric arc, an electric leakage, or the like is generated at the input terminal 12 or the output terminal 22, and an intermittent section 100, operatively associated with the solenoid 90, for preventing the abnormal electric current from flowing to a load.

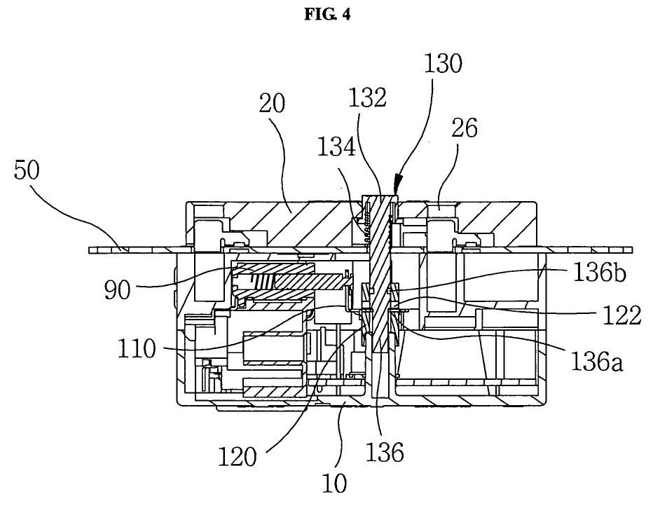

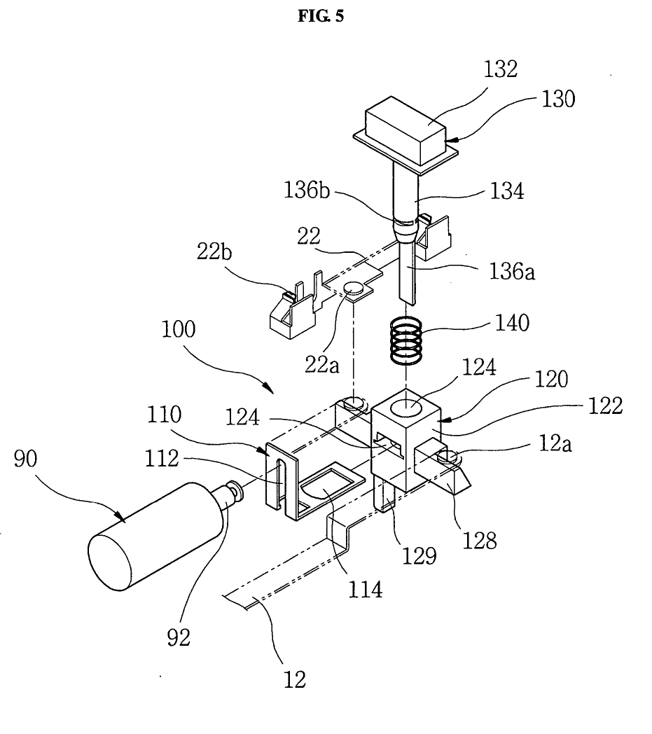

FIG. 4 is an exploded perspective view, as shown in the drawing, the intermittent section 100 includes a latchet 110 with which the plunger 92 of the solenoid 90 is associated, a housing 120 into which the latchet 110 is inserted and guided, and on which a contact of the input terminal 12 is placed, and a reset 130 inserted into the housing 120 and formed with a locking recess locked by the latchet 110.

The latchet 110 is formed with a guide hole 112 at an end of the latchet 110, by which the end of the plunger 92 of the solenoid 90 is locked, and formed with a locking hole 114 at the other end of the latchet 110 for intermitting the locking hole of the reset 130.

Preferably, the latchet 110 is made of an L-shaped thin plate formed with a guide hole 112 in the vertical direction and a locking hole 114 in the horizontal direction.

The housing 120 includes a body 122 formed with a locking passage 126 into which a plate portion formed with the locking hole 114 of the ratchet 110 is inserted and an insertion hole 124 into which the reset 130 is inserted in the vertical direction, supports 128, extended from the body 122, for supporting the contact of the terminal, and a pressing boss 129, formed at the lower side of the body 122, for pressing a reset switch 62 provided on a circuit board.

In other words, the housing 120 includes the body 122 formed with the locking passage 126 and the insertion hole 124 penetrating the body 122 in the vertical and horizontal directions to be crossed, the supports 128 extended from the sides of the body 122, and the pressing boss 129 extended from the lower side of the body 122.

The reset 130 includes a button body 132 protruding to the exterior of the cover 20, and a pestle 134 extended from the button body 132 and inserted into the insertion hole 124 of the housing 120.

The pestle 134 is formed with at least one locking recess locked by the locking hole 114 of the latchet 110. The locking recess is preferably formed with a first locking recess 136a having a semi-cylindrical locking portion made by cutting a side of a cylinder. The locking recess is preferably further formed with second locking recesses 136b having a predetermined depth at the upper portion of the first locking recess 136a at both sides of the pestle 134.

The reset 130 includes an elastic component for providing a restoring force after pressing. The elastic component is preferably a spring 140, and elastically supports the reset 130 and the yoke 50.

The operation of the receptacle according to the present invention constructed as described above will be described.

The electric power cables are connected to respective connecting terminals provided at the input terminal 12 and the output terminal 22 of the receptacle 1.

FIG. 5a is an enlarged view of main parts of the intermittent section, and FIG. 5b is a section view of the housing in FIG. 5a. As shown in the drawings, if the button body 132 of the reset 130 protruded through the button hole 23 of the cover 20 is pressed, the button body 132 is pressed in the state that the first locking recess 1 36a of the pestle 134 extended from the button body 132 is locked in the locking hole 114 of the latchet 110 inserted into the locking passage 122 of the housing 120.

At that time, the housing 120 is pressed by the pressure of the latchet 110 so as to press the reset switch 62 of the circuit board 60 located at the lower side of the pressing boss 126 formed at the lower end.

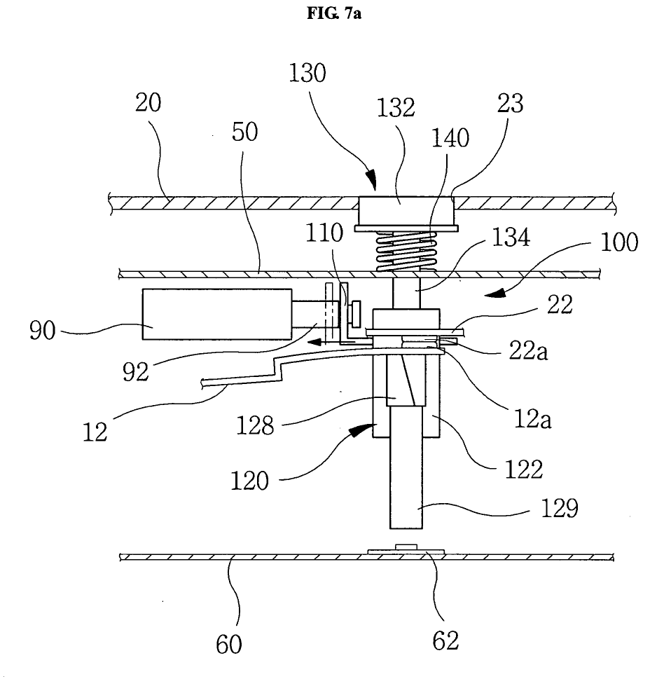

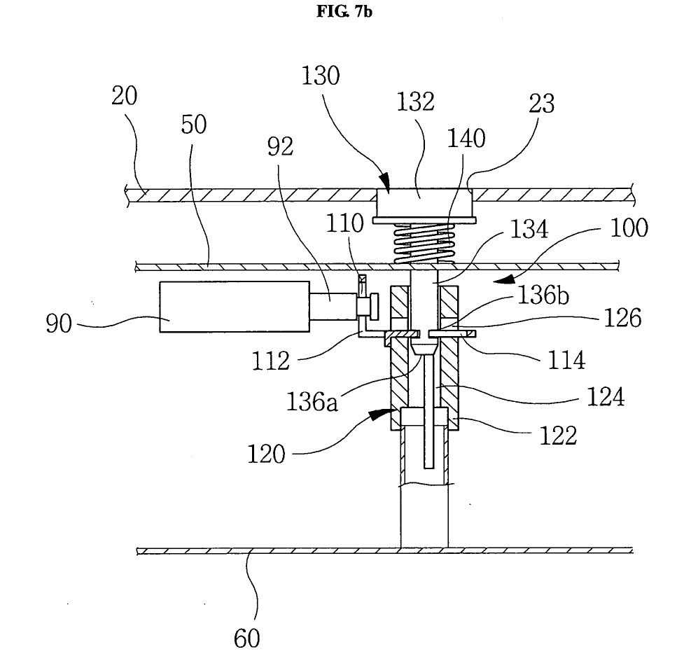

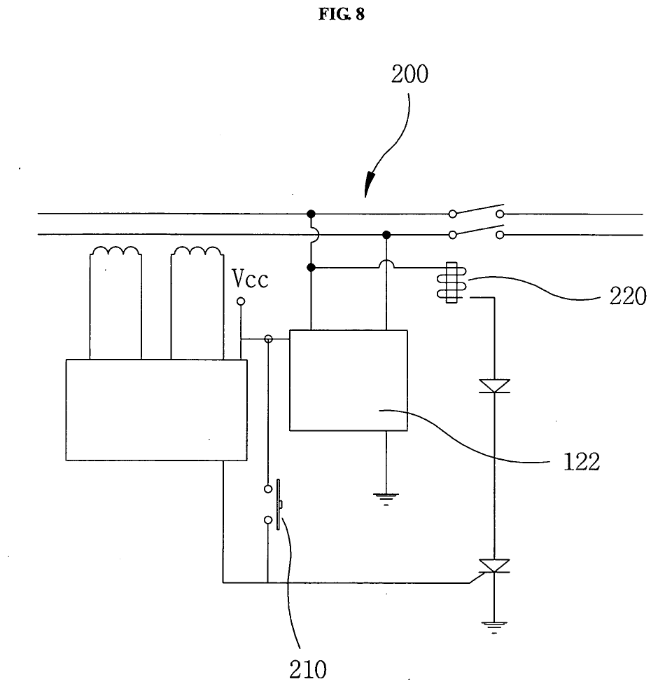

FIG. 7 is an electric circuit adopted in the present invention. As shown in the drawing, if the wiring of the input terminal 12 and the output terminal 22 of the receptacle 1 is normal, an electric power generating section 230 generates the electric power, the electric power is supplied to the electric circuit normally to activate the reset switch 210, and the solenoid 220 is magnetized by the signal from the reset switch 210.

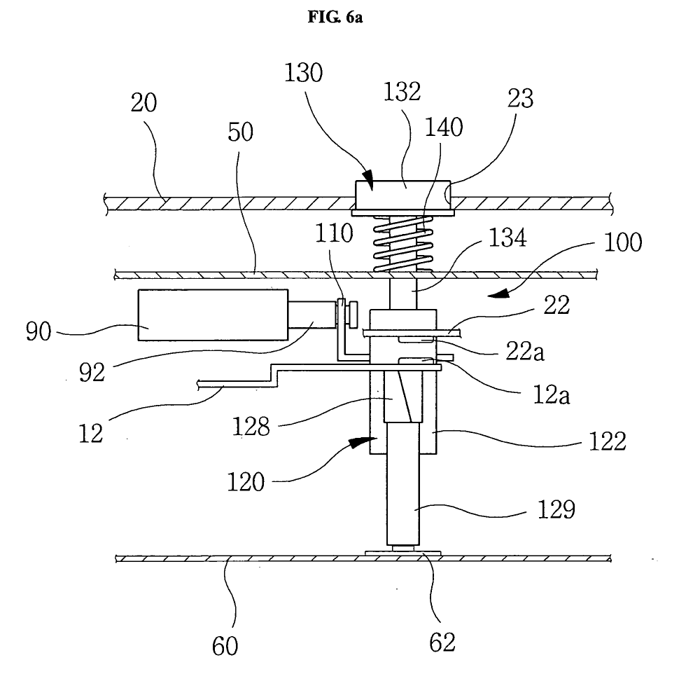

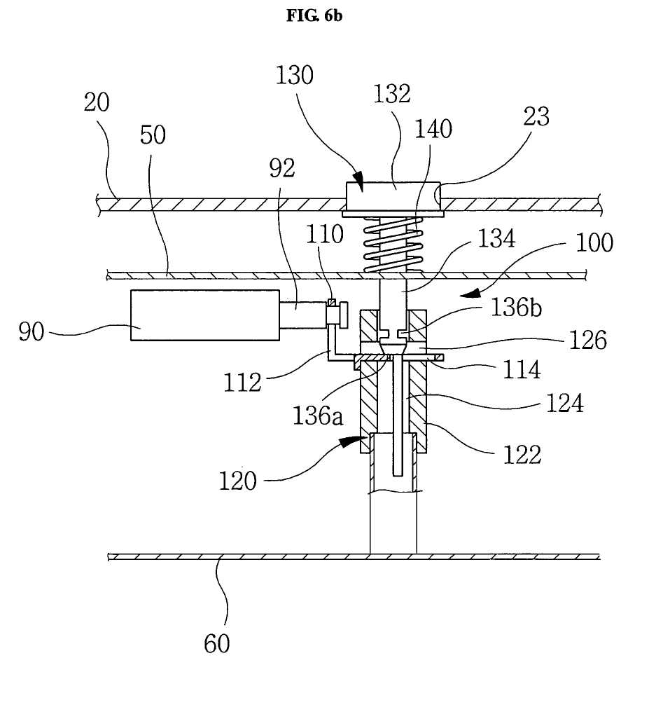

In addition, FIG. 6a is an enlarged partial view illustrating the operating state of the reset, and FIG. 6b is a section view of the housing in FIG. 6a. As shown in the drawings, the magnetization of the solenoid 90 makes the plunger 92 retreat to retreat the latchet 110 whose end is locked.

Here, the reset 130 is continuously pressed until the first locking recess 136a locked in the locking hole 114 is released due to the retreat of the latchet 110 so that the downward pressure by the operator is released.

Meanwhile, when the pressure by the operator is released, the reset 130 is elevated by the elastic force of the compression spring 140 disposed between the button body 132 and the yoke 50.

Moreover, the ascending reset 130 pushes the locking hole 114 of the ratchet 110 while the plunger 92 retreated by the magnetization of the solenoid 90 is restored, and is locked again when the second locking recess 136b of the pestle 134 ascending in the locking hole 114 is positioned.

Then, the reset 130 ascends due to the remained elastic force of the compression spring 140 so that the latchet 110 by which the second locking recess 136b is locked and the housing 120 accommodating the latchet 110 ascend together.

Therefore, the contact supported by the supports 128 of the housing 120, that is, the contact of the input terminal 12 ascends and comes in contact with the contact of the output terminal 22 so as to stably conduct due to normal wiring.

On the contrary, in the event that the wiring defect is occurred in the receptacle 1, in other words, in the event that the input terminal is connected with the output electric power cable and the output terminal is connected with the input electric power cable, if the reset 130 is pressed, the pressing boss 129 provided at the lower end of the housing 120 presses the reset switch 62 of the circuit board 60.

However, with reference to FIG. 7, since the electric power is not supplied to the input side including the electric power generating section 230, the solenoid 220 is not magnetized even when the signal of the reset switch 210 is generated.

In addition to, since the first locking recess 136a is maintained to locked by the locking hole 114 of the latchet 110, the reset 130 does not perform the operation in the normal wiring.

Therefore, the reset 130 is pressed as much as the pressing boss 129 presses the reset switch 62, the operator can easily detect the abnormal such as the wiring defect in the receptacle.

As described above, according to the receptacle of the present invention, since the abnormal state such as the wiring defect can be easily detected by pressing the reset button, it is possible to prevent the accident such as the breakdown of the office electric appliances or electric heaters when the abnormal electric current, such as the electric arc of the input terminal, the overload of the output terminal, or the like is generated.

Moreover, since the wiring defect can be easily detected even by a novice when wiring the electric power cables to the receptacle, it is convenient to work.

The present is not limited to the above structure, but can be changed or modified within the appending claims, for example, the receptacle can include light emitting diodes provided at the reset button or the test button so that the operator can easily detect the position of the receptacle and confirm whether the receptacle is normal or not.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

1. A receptacle comprising:
a main body;
a cover for covering the main body;
an input terminal and an output terminal received between the main body and the cover;
a solenoid provided with a plunger magnetized by a circuit signal when an abnormal electric current such as electric arc, an electric leakage, or the like is generated at the input terminal or the output terminal; and
an intermittent section, operatively associated with the solenoid, for preventing the abnormal electric current from flowing to a load;
the intermittent section including:
a latchet with which the plunger of the solenoid is associated;
a housing into which the latchet is inserted and guided, and on which a contact of the input terminal is placed; and
a reset inserted into the housing and formed with a locking recess locked by the latchet

2. The receptacle as claimed in claim 1, wherein the latchet is formed with a guide hole at an end of the latchet, by which the end of the plunger of the solenoid is locked, and formed with a locking hole at the other end of the latchet for intermitting the locking hole of the reset.

3. The receptacle as claimed in claim 1, wherein the housing comprises:
a body;
an insertion hole penetrating the side of the body in which a side of the reset is inserted;
a locking passage formed in the perpendicular direction to the insertion hole of the body for guiding an end of the latchet;
supports, extended from the body, for supporting the contact of the input terminal or the output terminal; and
a pressing boss, extended from a side of the body, for pressing a reset switch.

4. The receptacle as claimed in claim 1, wherein the reset includes:
a button body protruding to the exterior of the cover; and
a pestle extended from the button body, inserted into the insertion hole of the housing, and formed with at least one locking recess.

5. The receptacle as claimed in claim 1, wherein the intermittent section comprises:
a latchet formed with a guide hole at an end of the latchet, by which the end of the plunger of the solenoid is locked, and formed with a locking hole at the other end of the latchet for intermitting the locking hole of the reset;
a housing includes a body formed with an insertion hole into which a side of the latchet formed with the locking hole is inserted, a locking passage formed in perpendicular to the insertion hole of the body so as to guide the side of the latchet, at least one support, extended from the body, for supporting the contact of the input terminal or the output terminal, and a pressing boss, formed at the lower side of the body, for pressing a reset switch; and
a reset having a button body protruding to the exterior of the cover, and at least one pestle extended from the button body and inserted into the insertion hole of the housing.

6. The receptacle as claimed in claim 1, wherein the reset comprises an elastic component for providing a restoring force after pressing.

7. The receptacle as claimed in claim 6, wherein the elastic component comprises a compression spring.

8. The receptacle as claimed in claim 1, wherein, the locking recess comprises:
a first locking recess intermitted by being locked in the locking hole and maintained in the locked state when the solenoid is not magnetized due to the defect suxh as the wiring defect as pressing the reset; and
a second locking recesses for connecting the contact of the input terminal to the contact of the output terminal by which the first locking recess is locked again after the release from the locking hole of the latchet by which the solenoid is magnetized at the normal wiring that an abnormal signal is not detected.

9. The receptacle as claimed in claim 8, wherein the first locking recess has a semi-cylindrical shape formed by cutting a side of the cylinder.

10. The receptacle as claimed in claim 8, wherein the second locking recess has recesses formed on the sides of the pestle at a predetermined depth.
